(19) United States
(12) Patent Application Publication
(10) Pub. No.: US 2024/0042723 A1
(43) Pub. Date: Feb. 8, 2024

(54) DEVICE FOR PRODUCING PACKAGING MATERIAL FROM PAPER

(71) Applicant: PAPAIR GMBH, Hannover (DE)

(72) Inventors: Fabian SOLF, Hannover (DE); Steven WIDDEL, Hannover (DE); Bernd SUTTNER, Hohenpeißenberg (DE)

(21) Appl. No.: 18/277,539

(22) PCT Filed: Feb. 16, 2022
(86) PCT No.: PCT/EP2022/053777

§ 371 Date: Aug. 16, 2023

(30) Foreign Application Priority Data
Feb. 23, 2021 (DE) 10 2021 104 207.0
Dec. 20, 2021 (DE) 10 2021 133 913.8
Jan. 14, 2022 (DE) 10 2022 100 868.1

(51) Int. Cl. B31F 1/07

(52) U.S. Cl. CPC B31F 1/07; B31F 2201/0733; B31F 2201/0789

(57) ABSTRACT

The invention relates to a device and a method for producing packaging material from two paper webs, wherein shaped regions are created from at least one of the paper webs, the shaped regions projecting beyond the paper web and each being limited by a closed circumferential line in the paper web plane, and the paper webs, at their ends facing each other, consist exclusively of paper and are free of adhesive and connecting synthetic auxiliary material, in particular free of plastics film, and preferably after preconditioning of the paper webs are pressed against each other in such a way that, in connecting portions between the shaped regions, paper fibers of the one paper web are connected to paper fibers of the other paper web and the paper webs limit closed cavities in the region of the shaped regions.

### CROSS-REFERENCE TO RELATED APPLICATIONS

This application is a National Stage of International Application No. PCT/EP2022/053777, filed Feb. 16, 2022, which claims priority based on German Patent Application Nos. 10 2021 104 207.0, filed Feb. 23, 2021, 10 2021 133 913.8, filed Dec. 20, 2021, and 10 2022 100 868.1, filed Jan. 14, 2022, the entire disclosures of which are incorporated herein by reference.

### TECHNICAL FIELD

The invention relates to a device for producing packaging material from paper.

### BACKGROUND

To protect fragile or pressure-sensitive objects during shipping, bubble wrap made of plastic is often used, which consists of polyethylene, for example, and includes a plurality of bubble-like air pockets arranged along a regular pattern to achieve a cushioning effect. Because of the nub-like configuration of the air pockets, bubble wrap is often also referred to as “nub sheeting.”

Although corresponding bubble wrap made of plastic can be reused, in practice, however, any reuse fails, if for no other reason, because there is a lack of any system that collects the packaging material for targeted recycling.

Even though bubble wrap made of polyethylene, for example, is technically recyclable, in practice, any recycling involves a relatively high level of complexity and therefore correspondingly high costs. As a result, bubble wrap is often discarded after a single use. Since bubble wrap made of polyethylene is not biodegradable, this leads to substantial pollution of the environment. Plastic waste, among other things, caused by bubble wrap is often sent to so-called thermal recycling and incinerating.

To the extent that the bubble wrap is collected as part of a circulatory system, practice has shown that this does not prevent environmental pollution. To the contrary, plastics from the corresponding circulatory systems often find their way into the environment, especially into the oceans. Insofar as the plastic material is not degraded, it puts a strain on ecosystems and poses a danger for marine animals, for example. Insofar as the plastic material is shredded or degraded over time, for example, due to a mechanical impact and UV radiation, plastics particles are formed, especially in the form of microplastics, which remain in the environment or are ingested by living beings in their food.

The pollution of the environment due to plastics is exacerbated by the fact that the amounts of plastic waste from packaging material are continually increasing due to ever-growing quantities of parcels and postal shipments.

DE 604412 A discloses a packaging material in the form of a padded cushion made of several plies of paper for pressure-sensitive objects, which has at least one paper web with spherical or waffle-shaped embossing therein, and the paper webs are glued to each other.

DE 1 156701 A shows and describes a refinement of the packaging material known from the aforementioned publication, wherein the outside surfaces of the packaging material have glued thereto embossed cellulose wadding. A similar packaging material is also known from GB 893060A.

DE 10 2006 000 006 A1 discloses a method and an apparatus for producing a multi-ply fibrous web.

DE 622340 A discloses a packaging material in which several plies of the cushioning material known from DE 604412 A are placed one on top of the other and glued together.

WO 2020/227649 A1 shows and describes a multi-layer structure for cushioned shipping packaging with wavy embossed paper.

DE 69731 A shows and describes the production of corrugated cardboard.

US 2020/01 80255 A discloses a packaging material whose surface is arbitrarily crumpled in sections using a special apparatus to achieve a cushioning effect.

EP 0523382 B1 shows and describes an apparatus for producing a multi-ply packaging material. The packaging material consists of three embossed webs arranged one on top of the other.

EP 2 792 478 A1 discloses an apparatus for producing corrugated cardboard, in which a corrugated intermediate web is glued to two smooth carrier webs.

US 2018/0086021 A1 discloses a packaging material that consists of two webs that are laid one on top of the other having a wavy cross-section, of which one inside web is dimensionally stable and one outside web is flexible.

DE 1 156701 B discloses a so-called cushioning paper consisting of several embossed plies of paper, wherein the plies of paper are arranged one on top of the other and connected to one another by splices or corrugations.

EP 0650827 B1 shows and describes a corrugated cardboard-like packaging material in which a web with a wavy cross-section is arranged between two smooth webs and the webs are connected to one another by stampings.

EP 1 853419 B1 discloses a method and a device for producing multi-ply tissue paper.

EP 3683357 B1 discloses a multi-ply paper containing recycled paper and grass fibers.

The subsequently published publication WO 2021/046395 A1 discloses a packaging material consisting of several paper webs that is like bubble wrap, wherein the paper webs are connected to one another by an adhesive, fastening elements, such as staples, or by folding the edges.

### SUMMARY

It is the object of the invention to provide a packaging material that is improved compared to the known packaging materials.

This object is achieved by the invention as specified in claim 1.

A device according to the invention according to claim 1 for producing packaging material from paper has means for feeding at least a first paper web and a second paper web to an embossing region of the device and to a pressing region of the device, which is arranged downstream of the embossing region in the feed direction of the paper webs. An embossing apparatus for embossing the first paper web is arranged in the embossing region, wherein the embossing apparatus is designed and set up in such a way that shaped regions are created from the first paper web and project beyond the first paper web and each being limited by a closed circumferential line in the paper web plane of the first paper web.

Arranged in the pressing region, there is a pressing apparatus for press-fitting the paper webs together, in a manner that is free of adhesive and connecting synthetic auxiliary material, in particular free of plastics film, is arranged in the pressing region, the pressing apparatus being designed and set up in such a way that in connecting portions between the shaped regions, paper fibers of the first paper web connect to paper fibers of the second paper web and the paper webs limit closed cavities in the region of the shaped regions, with preconditioning means arranged in the feed direction upstream of the embossing region and/or the pressing region with at least one preconditioning apparatus for preconditioning the first paper web and/or the second paper web for embossing the first paper web or pressing the paper webs press-fitted together.

The invention provides a packaging material made of paper of the bubble wrap type, which has a first paper web and a second paper web, with shaped regions being created from at least one paper web which shaped regions project beyond the paper webs and are each limited by a closed circumferential line in the plane of the paper web. At least one of the paper webs thus forms an “embossing web” provided with shaped regions, while at least one other paper web can form a smooth “carrier web”. The shaped regions in the first paper web can, for example, have a diameter of about 10 mm and a height of about 3 to 4 mm.

According to the invention, a connection of paper fibers of the first paper web with paper fibers of the second paper web, or the fact that paper fibers of the first paper web connect or are connected with paper fibers of the second paper web, is understood to mean a mechanical connection of the paper fibers occurring when the paper webs are press-fitted against each other. When the paper webs are press-fitted against each other, paper fibers of the first paper web “interlock” with paper fibers of the second paper web and thus form a mechanical connection of the paper webs with each other.

According to the invention, on the surfaces that face each other, the paper webs consist exclusively of paper, and they and are free of adhesive and connecting synthetic auxiliary material, in particular free of plastics film, preferably, after preconditioning of the paper webs, the paper webs are press-fitted in such a way that, in connecting portions between the shaped regions paper fibers of the first paper webs are connected to paper fibers of the second paper web, and the paper webs limit closed cavities in the region of the shaped regions. According to the invention, a closed cavity is understood to mean a geometrically closed cavity, regardless of whether or not and, if so, to what extent the cavity is gastight.

The packaging material according to the invention is, in terms of its basic structure, similar to conventional bubble wrap made of plastic but consists, in contrast thereto, entirely of paper.

Due to the fact that, according to the invention, the paper webs are made exclusively of paper, and they are free of any adhesives and synthetic auxiliary materials, in particular, free of plastics film, the packaging material according to the invention can be easily and completely recycled.

The packaging material according to the invention thus reduces the burden on the environment to a considerable extent. In view of the large amounts of bubble wrap materials and similar packaging materials that are in use worldwide, this reduction of the environmental impact is significant, affording the invention great social benefits.

The invention avoids large amounts of plastic waste, which would otherwise have to be disposed of and which, as experience has shown, would, to a considerable extent, enter the environment, in particular the oceans.

Surprisingly, it has been found that the packaging material according to the invention has a cushioning effect comparable to that of conventional bubble wrap material made of plastic, even though the closed cavities formed in the shaped regions in the packaging material according to the invention are not gastight, in contrast to the air bubbles in conventional bubble wrap material made of plastic.

It has also been found that after preconditioning at least the “embossing web”, the webs are sufficiently firmly connected to one another by press-fitting them without the need for adhesives, other synthetic fasteners, plastics film or mechanical fasteners. According to the invention, the webs are connected to one another exclusively by the connection of the paper fibers of the webs that occurs during press-fitting after preconditioning.

Depending on the respective requirements and circumstances, at least one paper web can be preconditioned in any suitable manner by means of a preconditioning apparatus, in particular, by introducing moisture and heat into the relevant web. An advantageous refinement of the invention provides that at least one preconditioning apparatus is designed and set up for introducing or applying a preconditioning liquid, which, preferably, is water or contains water, into or onto at least one of the paper webs.

According to the invention, a preconditioning liquid can be introduced into or applied onto a paper web in any suitable manner, for example, by drawing the respective paper web through a bath of the preconditioning liquid, for example, a water bath. An advantageous refinement of the aforementioned embodiment provides that at least one preconditioning apparatus is designed and set up for spraying, nebulizing or evaporating a preconditioning liquid in such a way that the preconditioning liquid is sprayed, nebulized or evaporated onto the associated paper web.

A particularly advantageous refinement of the aforementioned embodiment provides that at least one preconditioning apparatus, in particular a preconditioning apparatus associated with the first paper web, is designed and set up for steaming the associated paper web with steam. The use of steam at a temperature of, for example, 100° C. to about 150° C. enables particularly effective preconditioning of the respective web, in that moisture and heat are introduced into the web at the same time.

According to the invention, in principle, it is sufficient if only the “embossing web”, i.e. the web in which the shaped regions are formed, is preconditioned. Advantageously, however, both the “embossing web” and the one or at least one of the “carrier webs” are preconditioned according to the invention. In principle, the webs can be preconditioned in an identical or similar manner. An advantageous refinement of the invention provides that each of the paper webs is associated with a separate preconditioning apparatus for separate, in particular, varying, preconditioning of the paper webs. The use of separate preconditioning apparatuses enables customizing the preconditioning of the webs.

In this context, a refinement of the invention provides that a first preconditioning apparatus is associated with the first paper web and that the same is arranged on the feed path of the first paper web to the embossing region, and a second preconditioning apparatus is associated with the second paper web, and it is arranged on the feed path of the second paper web to the pressing region.

An extraordinarily advantageous refinement of the invention provides that at least one preconditioning apparatus, in particular, the preconditioning apparatus associated with the second paper web, is designed and set up for introducing or applying a preconditioning liquid, preferably water, which contains cellulose fibers or cellulose particles, wherein the cellulose fibers or cellulose particles preferably are or contain microcellulose and/or nanocellulose, in particular, cellulose microfibers (CMF) and/or cellulose nanofibers (CNF). Using cellulose fibers, which are applied by means of a preconditioning liquid, which is preferably water, further improves the connection of the webs to one another, while preserving the basic idea of the invention of providing a packaging material which consists exclusively of paper. Accordingly, in this embodiment, too, recycling of the packaging material is not made more difficult by adhesives, plastics film or other synthetic additives. In the same way, other natural fibers can be used in addition to cellulose fibers or instead of cellulose fibers.

The embossing action of the “embossing web” can be done in different ways depending on the respective requirements and circumstances. An advantageous refinement of the invention provides in this regard that a roller arrangement with an embossing roller which is rotatably mounted about an embossing roller axis of rotation and which has embossing projections on its circumferential surface for forming the shaped regions in the first paper web, is arranged in the embossing region as an embossing apparatus, the embossing roller being engaged with a counter roller, which is rotatably mounted about an axis of rotation that is parallel to the embossing roller axis of rotation and has embossing recesses on its circumferential surface which are designed as complementary to the embossing projections of the embossing roller. In this way, embossing by means of a continuous method is enabled, while at the same time having a relatively simple and trouble-free structure of the device according to the invention for producing the packaging material according to the invention. According to the invention, any complementary design of the embossing recesses in the counter roller relative to the embossing projections in the embossing web is understood to mean that, when an embossing projection engages in an embossing recess, there is a gap remaining, whose gap width corresponds to the resulting thickness of the paper of the embossed paper web in the region of the shaped region. The shape, geometry and number of the embossing projections can be chosen within a wide range of limits, according to the respective requirements and circumstances.

Another advantageous refinement of the invention provides that a press roller which is rotatably mounted about a press roller axis of rotation is arranged in the pressing region as a pressing apparatus, and which, for the purpose of press-fitting the first paper web with the second paper web, cooperates with a counter roller, the axis of rotation of which is parallel relative to the press roller axis of rotation and spaced therefrom in such a way that a press roller gap is formed between the press roller and the counter roller for press-fitting the first paper web with the second paper web, away from the shaped regions in the connecting portions of the paper webs. In this embodiment, the webs are press-fitted against each other according to a continuous method, so that the packaging material according to the invention can be produced, in total, according to a continuous method. The contact pressure and/or the driving force that applies when the press roller is pressed against the counter roller during operation of the device, thereby forming the press roller gap inside which the paper webs, which are to be press-fitted against each other, are located during operation of the device, can be chosen and preferably set up within a wide range of limits in accordance with the respective requirements and circumstances.

In principle, according to the invention, the embossing region can be implemented in an embossing station, and the pressing region can be implemented in a pressing station spaced apart from the embossing region in the feed direction of the paper webs. An extraordinarily advantageous refinement of the invention provides in this regard that the counter roller of the embossing roller and the counter roller of the press roller are formed by a common counter roller, such that the roller arrangement has three rollers that are operatively engaged with one another. In this embodiment, the roller arrangement consisting of the embossing roller, the counter roller and the press roller forms a combined embossing/pressing station of the device. The roller arrangement herein is designed in the manner of a calender, with the roller arrangement according to the invention differing from an L-calender in that, in the simplest case, it has only three rollers, that is to say the embossing roller, the counter roller and the press roller, and, accordingly, the fourth and final roller in the conveying direction, which is present on an L-calender, is not required. A particular advantage of this embodiment is the fact that the shaped regions formed by the embossing roller in the “embossing web” will remain in the recesses of the counter roller until the webs are press-fitted against each other in the press roller gap between the counter roller and the press roll.

In the aforementioned embodiment, the counter roller axis of rotation is expediently arranged on a straight connecting line between the embossing roller axis of rotation and the press roller axis of rotation, as provided for in an advantageous refinement of the invention.

In order to be able to set up the gap width of the press roller gap, another advantageous refinement of the invention provides that a preferably motor-driven adjustment apparatus for setting the gap width of the press roller gap along a linear axis, running radially relative to the press roller axis of rotation, is associated with the press roller. This embodiment also enables the press roller to be completely disengaged from the counter roller if the device according to the invention is to be used for producing packaging material that consists exclusively of the “embossing web.” The adjustment apparatus can, in particular, be an electromotor adjustment device that is controllable by a control device.

According to another advantageous refinement of the invention, a heating device for heating the respective rollers is associated with the embossing roller and/or the counter roller and/or the press roller, preferably for setting the temperatures of the rollers separately. During the pressing process, moisture is pressed out of the webs, wherein, by heating the rollers, the webs are being pre-dried during the embossing or pressing processes. By setting the temperatures of the rollers accordingly, this pre-drying action can be controlled according to the respective requirements and circumstances.

In the aforementioned embodiment, a temperature sensor is preferably associated with the embossing roller and/or the counter roller and/or the press roller for the purpose of detecting the temperature of the respective rollers.

In order to further dry the webs that have been press-fitted against each other in order to achieve a desired residual moisture content of the end product, namely the packaging material, another advantageous refinement of the invention provides that drying means for drying the paper webs, that were press-fitted in the pressing region, are arranged in the feed direction between the pressing region and a storage means for the finished packaging material. In addition to achieving a desired residual moisture content in the finished packaging material, the drying action has the effect of increasing the strength of the connection between the paper webs.

The number, heat output and structural configuration of the drying means can be chosen within a wide range of limits, according to the respective requirements and circumstances. Advantageous refinements of the invention provide that the drying means have at least two drying apparatuses spaced apart from one another in the feed direction, and/or that at least one drying apparatus is designed as an infrared radiation drying apparatus and at least one drying apparatus is designed as a hot-air drying apparatus. At least one hot-air drying apparatus therein is preferably arranged downstream of at least one infrared radiation drying apparatus in the feed direction of the paper webs.

Another advantageous refinement of the invention provides that the press roller consists of an elastically flexible material, in particular, silicone, at least on its circumferential surface.

The disclosure of the present application and subject matter of the invention also include, a method for producing packaging materials made from paper, wherein at least one first paper web and at least one second paper web are fed to an embossing region and, in the feed direction of the paper webs, to a pressing region downstream of the embossing region, wherein shaped regions are created from the first paper web in the embossing region by means of an embossing apparatus, with the shaped regions projecting beyond the first paper web and each being limited by a closed circumferential line in the paper web plane of the first paper web, wherein the paper webs, free of adhesive and connecting synthetic auxiliary material, in particular free of plastics film, are press-fitted against each other in the pressing region by means of a pressing apparatus in such a way that, in connecting portions between the shaped regions, paper fibers of the first paper web connect to paper fibers of the second paper web, and wherein the paper webs limit closed cavities in the region of the shaped regions, wherein, in preparation for the embossing action in the embossing region or press-fitting the paper webs together in the pressing region, the first paper web and/or the second paper web are/is preconditioned.

Advantageous and expedient refinements of the method according to the invention are specified in the dependent claims which refer back to claim 19. The same advantages and properties result as those relative to the device according to the invention and the refinements thereof.

The method according to the invention can be carried out, in particular, using a device according to the invention.

The disclosure of the present application and subject matter of the invention also include a packaging material made of paper having a first paper web and a second paper web, wherein shaped regions are created from at least one paper web, the shaped regions projecting beyond the paper web and each being limited by a closed circumferential line in the paper web plane, wherein the paper webs, on their surfaces facing one another, are made exclusively of paper, and they are press-fitted against each other free of adhesive and connecting synthetic auxiliary material, in particular, free of plastics film, preferably after preconditioning of the paper webs, in such a way that, in connecting portions of the paper webs between the shaped regions paper fibers of the first paper web are connected to paper fibers of the second paper web and the paper webs limit closed cavities in the region of the shaped regions.

A shaped region within the meaning of the invention is understood to mean an embossing in a paper web that projects beyond the plane of the paper web. If, according to a preferred embodiment, the packaging material according to the invention made of an “embossing web” that is provided with shaped regions and a smooth “carrier web”, the shaped regions projecting beyond the paper web plane together with the “carrier web” limit cavities, so that the packaging material according to the invention is formed in a manner like bubble wrap. A shaped region can be formed in particular in the form of nubs, as is known from bubble wrap made of plastic.

Depending on the respective requirements and circumstances, the shape and size of the shaped regions that are created in the first paper web can be chosen within a wide range of limits. An advantageous refinement of the invention provides in that regard that the circumferential line limiting a shaped region is circular or approximately circular such that the shaped regions are formed like spherical surfaces. A corresponding shape of the shaped regions is advantageous, on the one hand, in terms of the desired cushioning effect of the packaging material and, on the other hand, with regard to production.

The packaging material according to the invention for the packaging of objects sensitive to breakage or pressure can be provided in a variety of ways, for example, and in particular, in the form of material sold in the form of a web, which can be cut by the user according to the size of the object to be packaged. The packaging material according to the invention can also be provided in the form of prefabricated blanks. For example, the packaging material according to the invention can also be designed as a shipping box or in the manner of a cushioned envelope, or it can form part of such packaging materials.

Depending on the requirements and circumstances, the number of paper webs from which the packaging material according to the invention is made can be chosen from a wide range limits. For example, the packaging material according to the invention can be made of more than two paper webs. For example and in particular, the packaging material according to the invention can be made of an “embossing web,” that is provided with shaped regions and a smooth “carrier web”. An alternative embodiment of the invention relative to the above provides that shaped regions are created from both paper webs and that the paper webs are connected to one another in such a way that shaped regions in one paper web correspond to the shaped regions in the other paper web and are arranged opposite one another. In this embodiment, the shaped regions in one paper web together with the shaped regions in the other paper web limit the cavities of the packaging material according to the invention.

Another advantageous refinement of the packaging material according to the invention provides that the shaped regions form a regular pattern; in particular, they are arranged in rows and/or columns.

Any suitable paper can be used as starting material for the packaging material according to the invention. A particularly advantageous refinement of the invention provides that the paper webs are made of recycled paper or contain recycled paper. This embodiment is particularly environmentally friendly, because the use of fresh paper, the production of which involves high energy consumption, is completely or at least partially avoided.

A further refinement of the aforementioned embodiment provides that the recycled paper has at least one, in particular, all of the following characteristic parameters:
specific basis weight/grammage [ISO 536]: 60-140 g/m2
water absorption according to Cobb60 [ISO 535]: 26-113 g/m2
roughness according to Bendtsen [ISO 8791-2]: ≥300 ml/min
bursting strength [ISO 2758]: 160-240 kPa
SCT INDEX in cross direction [ISO 9895]: 1.1-1.9 kN/m

According to an advantageous refinement of the packaging material according to the invention, the connecting portions between the shaped regions are designed in a bridge-like manner.

Another advantageous refinement of the invention provides that the paper webs are compressed at least in sections in the connecting portions.

The subject matter of the invention also includes the use of recycled paper in the production of a packaging material, which has at least one paper web from which shaped regions are created, which project beyond the paper web and are each limited by a closed circumferential line in the paper web plane, wherein the recycled paper has at least one, in particular, all of the following characteristic parameters:
specific basis weight/grammage [ISO 536]: 60-140 g/m2
water absorption according to Cobb60 [ISO 535]: 26-113 g/m2
roughness according to Bendtsen [ISO 8791-2]: ≥300 ml/min
bursting strength [ISO 2758]: 160-240 kPa
SCT INDEX in cross direction [ISO 9895]: 1.1-1.9 kN/m

The invention will be explained in more detail below with reference to the attached, highly schematic drawing using exemplary embodiments. It is apparent to a person skilled in the art that the individual features of an exemplary embodiment refine the exemplary embodiment on its own, i. e. independently of the other features. It is therefore also apparent to the person skilled in the art that all the features described, shown in the drawings and claimed in the claims, taken individually and taken in any technically meaningful combinations, form the subject matter of the invention, regardless of their combination in the claims and their back-references as well as regardless of their specific description or representation in the drawings. The subject matter and disclosure of the present application also include combinations of features of the device claims with features of the method claims. The subject matter and disclosure of the present application also include combinations of features of one exemplary embodiment with features of another exemplary embodiment. The subject matter and disclosure of the present application also include sub-combinations of the claims in which at least one feature of a claim is omitted or replaced by another feature.

### BRIEF DESCRIPTION OF THE DRAWINGS

In the figures:

FIG. 1 shows, highly schematically and sketch-like, a first exemplary embodiment of a device according to the invention for the production of packaging material,

FIG. 2 shows a schematic side view of the exemplary embodiment according to FIG. 1

FIG. 3 shows a schematic perspective view of the exemplary embodiment according to FIG. 1,

FIG. 4 shows a schematic radial view of a roller arrangement of the exemplary embodiment according to FIG. 1,

FIG. 5 shows a perspective view of the roller arrangement according to FIG. 4,

FIG. 6 shows a sectional view along line A-A in FIG. 5 of the roller arrangement according to FIG. 4,

FIG. 7 shows a perspective view of an embossing roller of the roller arrangement according to FIG. 4,

FIG. 8 shows a counter roller of the roller arrangement according to FIG. 4 in the same representation as FIG. 7,

FIG. 9 shows a sketch of the structure of an exemplary embodiment of a web tension sensor of the device according to FIG. 1,

FIG. 10 shows the structure of a system control of the device according to FIG. 1 in the form of a block diagram,

FIG. 11 shows a top view of a web of an exemplary embodiment of a packaging material according to the invention in the form of bubble wrap,

FIG. 12 shows a section through the packaging material according to FIG. 11 in the area of the shaped region on greatly larger scale than FIG. 11, and

FIG. 13 shows a second exemplary embodiment of a device according to the invention in a representation similar to FIG. 1.

### DETAILED DESCRIPTION

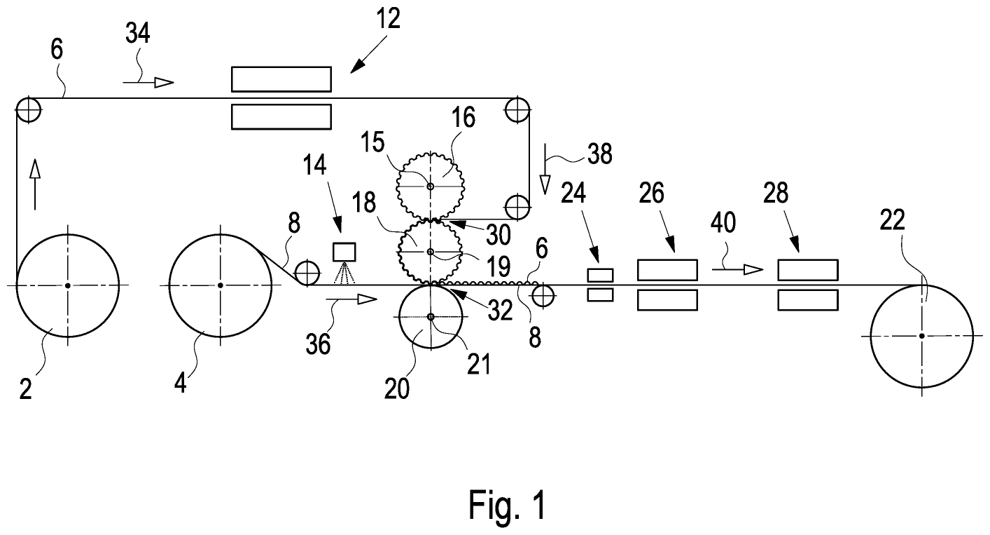

A first exemplary embodiment of a device according to the invention for producing packaging material from paper is explained in more detail below with reference to FIGS. 1 to 10.

FIG. 1 shows, highly schematically and sketch-like, an exemplary embodiment of a device or system according to the invention for the production of packaging materials made of paper whose functionality is briefly described as follows:

From storage rolls 2, 4, a first paper web 6 and a second paper web 8, which are also referred to as “webs” for short below, are fed into a roller arrangement 10 via deflectors. The first paper web therein forms an “embossing web” from which shaped regions 11 are created by means of the roller arrangement 10, while the second paper web forms a smooth “carrier web” that carries the embossing web in the finished packaging material and that is, for this purpose, press-fitted with the “embossing web” by means of the roller arrangement 10. For the embossing action, the “embossing web” is preconditioned in the feed direction, upstream of the roller arrangement 10, at reference numeral 12, by means of steaming the same with steam.

For example and in particular, steam at a temperature of between 100° C. and about 150° C. can be used.

In the illustrated exemplary embodiment, the paper webs 6, 8 are made of recycled paper. According to the invention, however, the paper webs 6, 8 can also be made of any other suitable paper, depending on the respective requirements and circumstances.

In the feed direction, before the roller arrangement 10, at reference numeral 14, the “carrier web” is preconditioned by spraying it with a liquid containing cellulose fibers or particles, in particular, nanocellulose, preferably in the form of cellulose nanofibers (CNF).

The roller arrangement 10 has an embossing roller (positive roller) 16 which is engaged with a counter roller (negative roller) 18. The paper web 6 is embossed between the rollers 16, 18 to form the shaped regions. The embossing roller 16, the counter roller 18 and a press roller are also referred to as “rollers” for short below.

The press roller 20 is engaged with the counter roller 18, wherein the paper webs 6, 8 are press-fitted against each other between the counter roller 18 and the press roller 20, in a manner that is free of adhesive and connecting synthetic auxiliary material, in particular free of plastics film.

The paper webs 6, 8, press-fitted against each other, which form the packaging material according to the invention in the manner of bubble wrap, are fed to a storage means 22 in the form of a storage roll for the finished bubble wrap-like packaging material made exclusively of paper, wherein a multi-stage drying apparatus with three dryers 24, 26 and 28 is arranged within the feed path. The dryer 24 therein is an IR radiator, while the dryers 26 and 28 are hot air dryers.

The structure of the device is as follows:

The device has means for feeding at least the first paper web 6 and the second paper web 8 to an embossing region 30 and a pressing region 32, which is downstream of the embossing region 30 in the feed direction of the paper webs.

The feed direction or conveying direction of the paper webs 6, 8 or of the press-fitted paper webs 6, 8 is marked in FIG. 1 by arrows 34, 36, 38 and 40.

An embossing apparatus 31 for embossing the first paper web is arranged in the embossing region 30 in such a way that shaped regions 11 are created from the first paper web 6, which project beyond the first paper web 6 and are each limited by a closed circumferential line in the paper web plane of the first paper web 6. In the illustrated exemplary embodiment, the closed circumferential line is circular or approximately circular.

A pressing apparatus 33 is arranged in the pressing region 32 for press-fitting the paper webs 6, 8 together, and doing so free of any adhesives and connecting synthetic auxiliary materials, in particular, free of plastics film, in such a way in such a way that in connecting portions between the shaped regions paper fibers of the first paper web 6 connect with paper fibers of the second paper web 8 and the paper webs 6, 8 limit closed cavities in the region of the shaped regions.

Preconditioning means with at least one preconditioning apparatus for preconditioning the first paper web 6 and/or the second paper web 8 are arranged in the feed direction upstream of the embossing region 30 and/or the pressing region 32.

According to the invention, at least one preconditioning apparatus is designed for introducing or applying a liquid, in particular, a preconditioning liquid consisting of water or containing water, into or onto at least one of the paper webs 6, 8. In the illustrated exemplary embodiment, reference numeral 12 denotes a preconditioning apparatus for applying or introducing water in the form of steam onto or into the first paper web 6 in order to precondition it for the embossing action in the embossing region 30.

According to the invention, at least one preconditioning apparatus is designed and set up for spraying, nebulizing or evaporating a preconditioning liquid in such a way that the preconditioning liquid is sprayed, nebulized or vaporized onto the associated paper web.

In the illustrated exemplary embodiment, a separate preconditioning apparatus is associated with each of the paper webs 6, 8 for separate, in the illustrated exemplary embodiment different, preconditioning of the paper webs 6, 8.

In detail, the first preconditioning apparatus 12 is associated with the first paper web 6 and arranged on the feed path of the first paper web to the embossing region 30. and a second preconditioning apparatus 14 is associated with the second paper web 8 and arranged on the feed path of the second paper web 8 to the pressing region.

The first preconditioning apparatus 12, associated with the first paper web 6, is designed in the illustrated exemplary embodiment for steaming the first paper web with steam at a temperature of between 100° C. and approximately 150° C.

The second preconditioning apparatus 14, associated with the second paper web, is designed and set up for applying or introducing a preconditioning liquid into or onto the second paper web 8, wherein the preconditioning liquid in the illustrated exemplary embodiment is water containing cellulose fibers or cellulose particles, wherein the cellulose fibers or cellulose particles preferably are or contain microcellulose and/or nanocellulose, in particular, cellulose microfibers (CMF) and/or cellulose nanofibers (CNF). The content of cellulose fibers in the preconditioning liquid is chosen in such a way that it can be sprayed and is sprayed onto the second paper web 8.

A roller arrangement 10 with an embossing roller 16, which is rotatably mounted about an embossing roller axis of rotation 15, is arranged in the embossing region 30 and which embossing roller 16 has embossing projections on its circumferential surface for forming the shaped regions 11 on the first paper web 6, wherein the embossing roller 16 being engaged with a counter roller 18, which is rotatably mounted about an axis of rotation 19 parallel to the embossing roller axis of rotation, and which has embossing recesses in its circumferential surface which are designed to be complementary relative to the embossing projections of the embossing roller 16.

A press roller 20, which is rotatably mounted about a press roller axis of rotation 21, is arranged in the pressing region 32, and which, in order to press-fit the first paper web 6 with the second paper web 8, cooperates with a counter roller 18, the axis of rotation of which is parallel relative to the press roller axis of rotation and spaced apart in such a way that a press roller gap is formed between the press roller 20 and the counter roller 18 for press-fitting the first paper web 6 with the second paper web 8 away from the shaped regions 11 in the first paper web 6.

The press roller 20 has a smooth circumferential surface and consists of an elastically flexible material on its circumferential surface; in the illustrated exemplary embodiment, this is silicone.

In the illustrated exemplary embodiment, the counter roller of the embossing roller 16 and the counter roller of the press roller 20 are formed by one common counter roller, namely counter roller 18, in such a way that the roller arrangement 10 has three operatively connected or operatively engaged rollers 16, 18, 20. It can be seen that, in the illustrated exemplary embodiment, the embossing roller 16 forms the embossing apparatus 31 together with the counter roller 18, and the press roller 20 forms the pressing apparatus 33 together with the counter roller 18.

It can be seen that, in the illustrated exemplary embodiment, the counter roller 18 and the press roller 20 are in a direct press engagement with each other, i. e. without the interposition of conveyor sections for the first paper web 6 that is embossed by means of the embossing roller 16. In this way, the paper webs 6, 8 are press-fitted against each other, while the shaped regions 11 created from the first paper web by means of the embossing roller 16 are still in the embossing recesses of the counter roller 18. As a result, the roller arrangement 10 consisting of the rollers 16, 18 and 20 forms a combined embossing and pressing station.

As can be seen from FIG. 1, in the illustrated exemplary embodiment, the axis of rotation 19 of the counter roller 18 is arranged on a connecting line between the embossing roller axis of rotation 15 and the press roller axis of rotation 21.

In the illustrated exemplary embodiment, the press roller 20 has preferably associated thereto a motor-operable adjustment apparatus for setting the gap width of the press roller gap along a linear axis running radially relative to the press roller axis of rotation 21 in the exemplary embodiment. The adjustment apparatus also enables disengaging the press roller 20 from the counter roller 18 when a packaging material is to be produced that consists exclusively of a single web provided with shaped regions, i.e. exclusively an “embossing web” without a “carrier web”.

Furthermore, according to the invention, a heating device for heating the respective roller is associated with the embossing roller 16 and/or the counter roller 18 and/or the press roller 20. In the illustrated exemplary embodiment, a separate heating device is associated with each of the rollers 16, 18, 20 so that the temperature for each of the rollers 16, 18, 20 can be set separately. To this end, a temperature sensor for detecting the temperature of the respective roller 16 or 18 or 20 is preferably associated with the embossing roller 16 and/or the counter roller 18 and/or the press roller 20. It is advantageous herein when both the heating device, for example in the form of at least one electric heating rod, and the temperature sensor are integrated in the respective roller 16 or 18 or 20, as is the case in the illustrated exemplary embodiment. In this way, the structural setup of the device according to the invention is simplified.

According to the invention, drying means for drying the paper webs 6, 8 that are press-fitted against each other in the pressing region 32 are arranged in the feed direction between the pressing region 32 and a storage means in the form of a storage roll 22 for the finished packaging material.

In the illustrated exemplary embodiment, the drying means have at least two drying apparatuses spaced apart from one another in the feed direction or conveying direction, wherein at least one drying apparatus is designed as an infrared radiation drying apparatus and at least one drying apparatus is designed as a hot-air drying apparatus. In the illustrated exemplary embodiment, a drying apparatus 24 disposed immediately downstream of the pressing region 32 is designed as an infrared radiation drying apparatus, while two drying apparatuses 26, 28 in the feed direction or conveying direction downstream of the drying apparatus 24 can be designed as hot-air drying apparatuses.

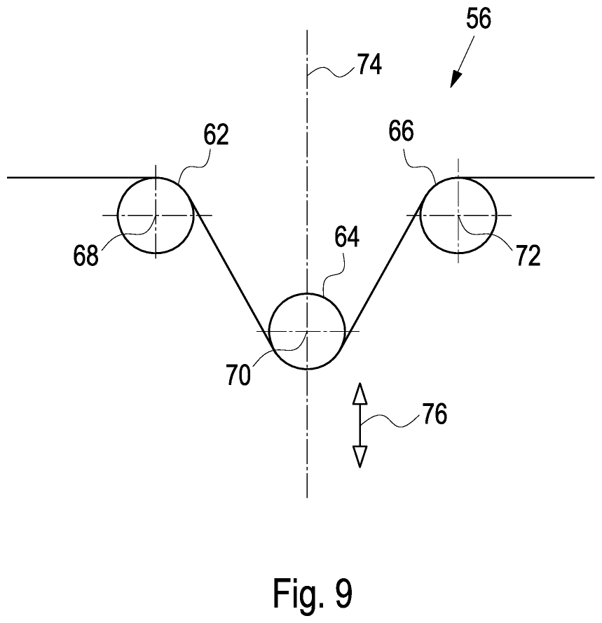

The web tension of the individual paper webs 6 and 8 and/or the paper webs press-fitted against each other is monitored by suitable sensors according to the respective requirements and circumstances. This is explained in more detail below with reference to FIG. 9.

Rollers 16, 18 and 20 can be made of any suitable material. In particular, the circumferential surfaces of the rollers 16, 18 and 20 can be made of a different material than the respective roller body, or they can be coated with another material. In particular, the press roller 20 can be made of an elastically flexible material, in particular, silicone, at least on its circumferential surface, as is the case in the illustrated exemplary embodiment. In contrast, the embossing roller 16 and the counter roller 18 can be made of a dimensionally stable material, for example metal, at least on their circumferential surface.

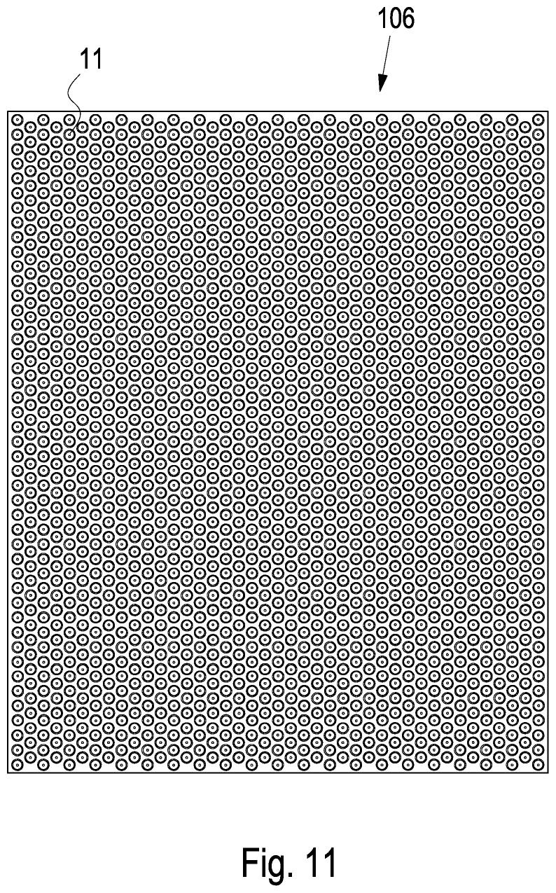

Rollers 16, 18 and 20 can each be driven in rotation independently of one another by means of a separate rotary drive device. The same applies for the storage rolls 2, 4 and 22, which can also each be driven in rotation independently of one another by means of a separate rotary drive device. The control of the rotary drive devices associated with the rollers 16 or 18 or 20 and the storage rolls 2 or 4 or 22 is explained in more detail below with reference to FIG. 11.

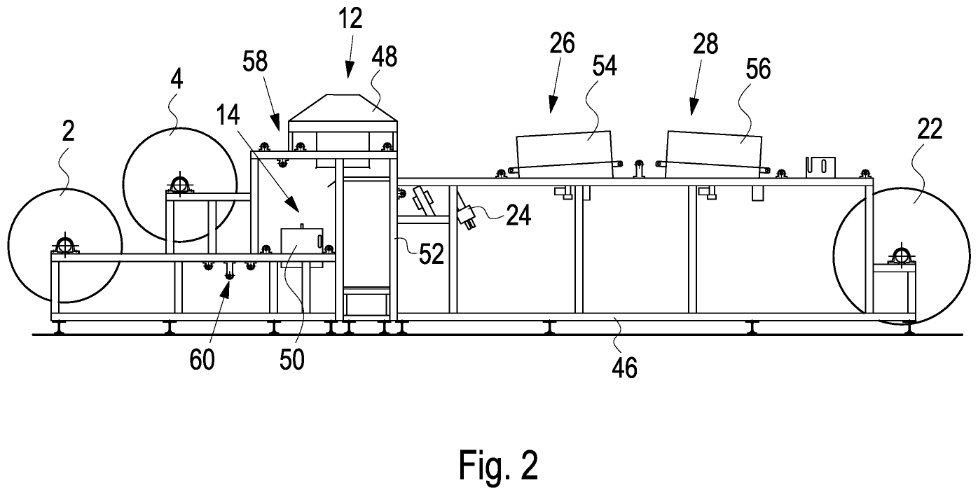

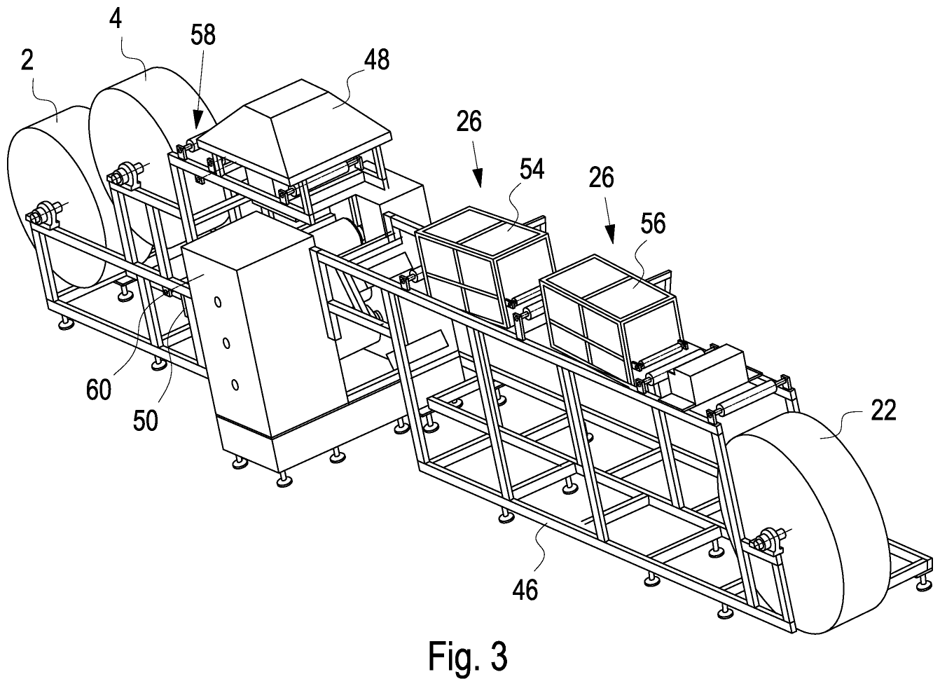

FIG. 2 shows a schematic side view of the exemplary embodiment of FIG. 1, while FIG. 3 shows a schematic perspective view of the exemplary embodiment.

As illustrated in FIGS. 2 and 3, the device has a frame 46 on which its various assemblies and components are arranged.

The first preconditioning apparatus 12 has a housing 48. Excess water that remains after the first paper web 6 has been steamed with water is collected in the housing 48 or sucked off as steam and can be drained off and then reused or disposed of. Since the excess water is free of chemical additives, it can be disposed of in the sewage system without polluting the environment.

In a manner corresponding thereto, the second preconditioning apparatus 14 has a housing 50. Excess preconditioning liquid that remains after the second paper web 8 has been preconditioned is collected in the housing 50 and can be drained off and then reused or disposed of Since the preconditioning liquid in the illustrated exemplary embodiment consists exclusively of water with added cellulose nanofibers and is therefore free of chemical additives, it can also be disposed of in the sewage system without polluting the environment.

Reference numeral 52 in FIGS. 2 and 3 denotes a housing in which the roller arrangement 10 is accommodated.

Reference numerals 54 and 56, respectively, denote housings in which the hot-air drying apparatuses 26 and 28 are accommodated, respectively. Liquid removed from the webs 6, 8 during drying in the hot-air drying apparatus 26, 28, which can consist of water in the illustrated exemplary embodiment, can escape from the housings 54, 56, which, for this purpose, are open in each case at their front and rear ends in the feed direction.

As explained above with respect to the preconditioning apparatuses 12, 14, the resulting liquid can also be disposed of in the sewer system without polluting the environment.

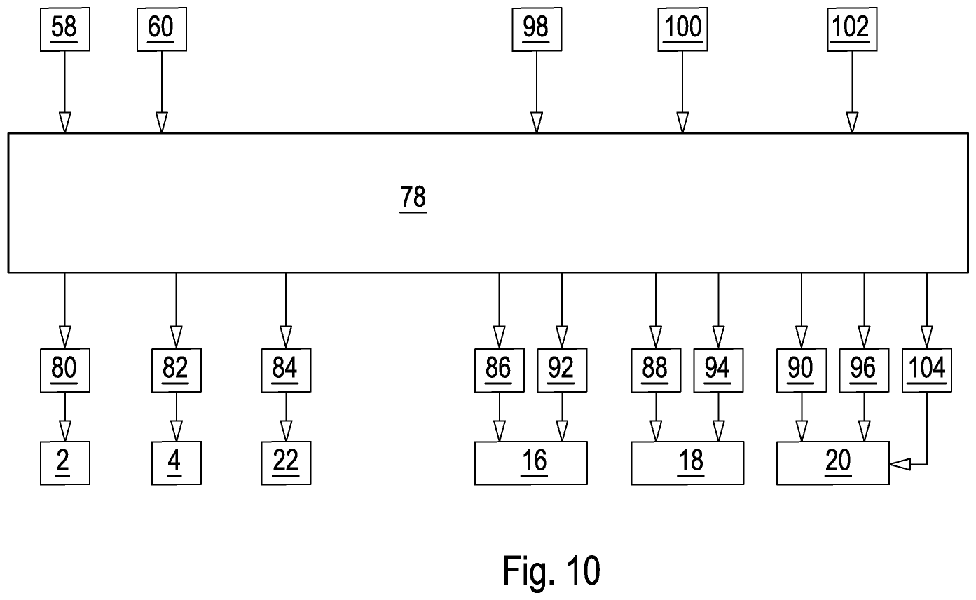

Reference numeral 58 denotes a web tension sensor, arranged in the feed direction between the storage roll 2 and the first preconditioning apparatus 12, for sensing or measuring the web tension of the first paper web 6. The structure of the web tension sensor 58 will be explained in more detail below with reference to FIG. 10. In corresponding manner, a web tension sensor is associated with the second paper web and is denoted by reference numeral 60. The web tension sensor 60 is constructed in the same way as the web tension sensor 58 and is therefore not explained in more detail.

All system parameters of the device and/or system, in particular, the feed rate or conveying rate of the paper webs, the web tension, the speed and temperature of the rollers 16, 18 and 20 and the operating parameters of the preconditioning apparatuses 12, 14 and the drying apparatuses 24, 26 and 28 are controlled by a central system control, which will be explained in more detail further below with reference to FIG. 11.

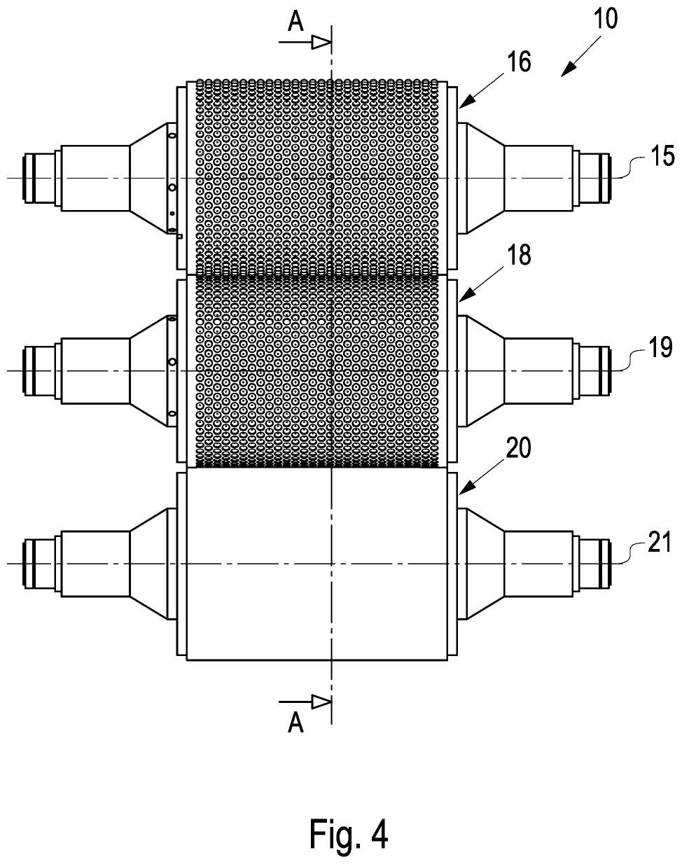

The roller arrangement 10 and its embossing roller 16 and the counter roller 18 are shown in different views in FIGS. 4 to 8.

FIG. 4 shows a radial view of the roller arrangement 10.

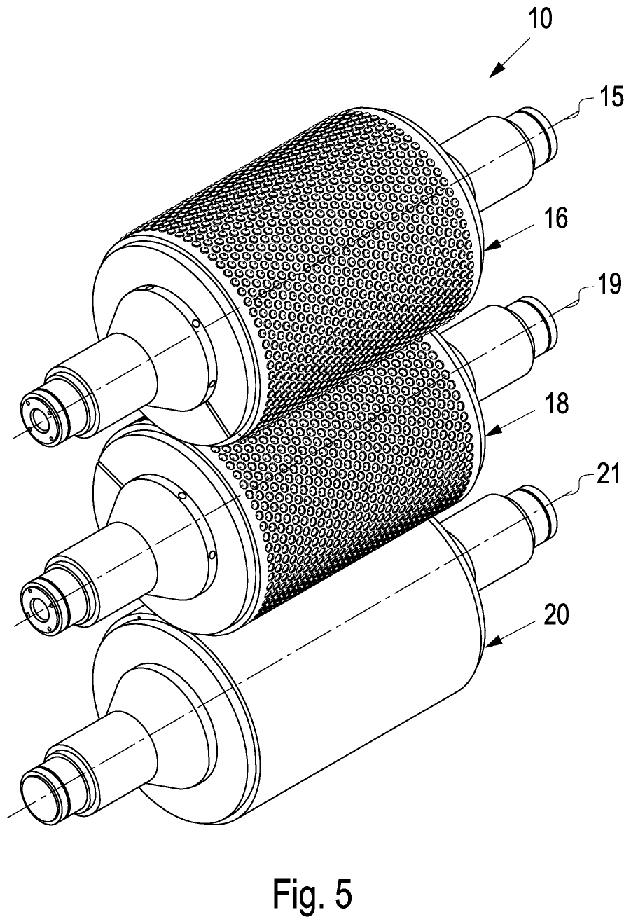

FIG. 5 shows a perspective view of the roller arrangement 10.

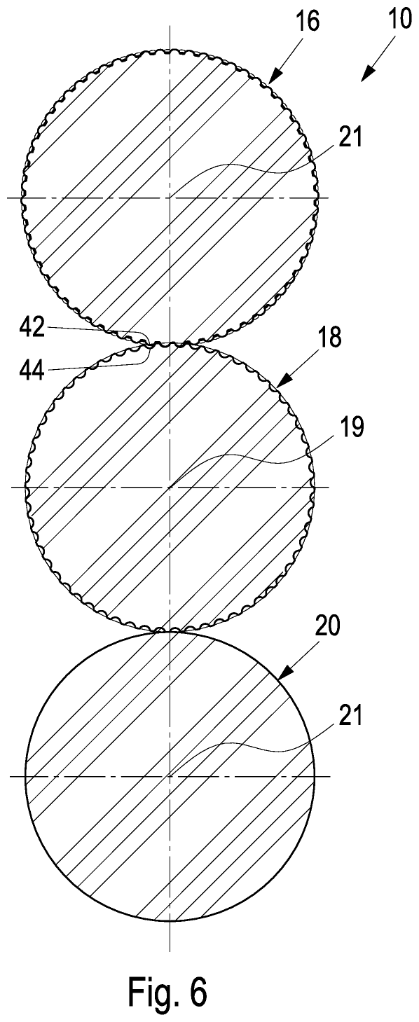

FIG. 6 shows a radial sectional view of the roller arrangement 10 along line A-A depicted in FIG. 4.

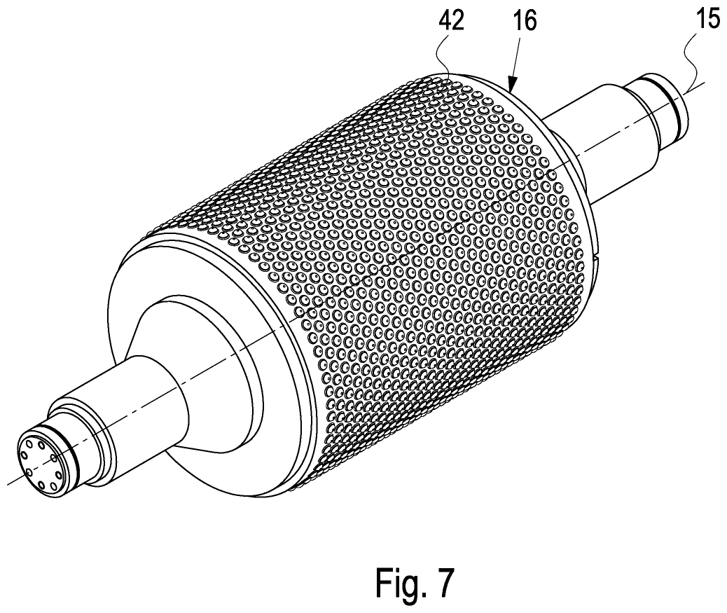

FIG. 7 shows a perspective view of the embossing roller 16, wherein embossing projections can be seen that are provided on the circumferential surface of the embossing roller 16 and project beyond the circumferential surface, of which only one embossing projection is provided, with the reference numeral 42, in FIG. 7. In the illustrated exemplary embodiment, the embossing projections 42 are designed in the manner of a sphere or a spherical surface. In the illustrated exemplary embodiment, successive rows of embossing projections 42 are arranged in the circumferential direction of the embossing roller 16 on its circumferential surface, with successive rows in the circumferential direction being arranged relative to one another in such a way that the embossing projections are arranged as “staggered.” The shape, geometry and number of embossing projections can be chosen within a wide range of limits according to the respective requirements and circumstances.

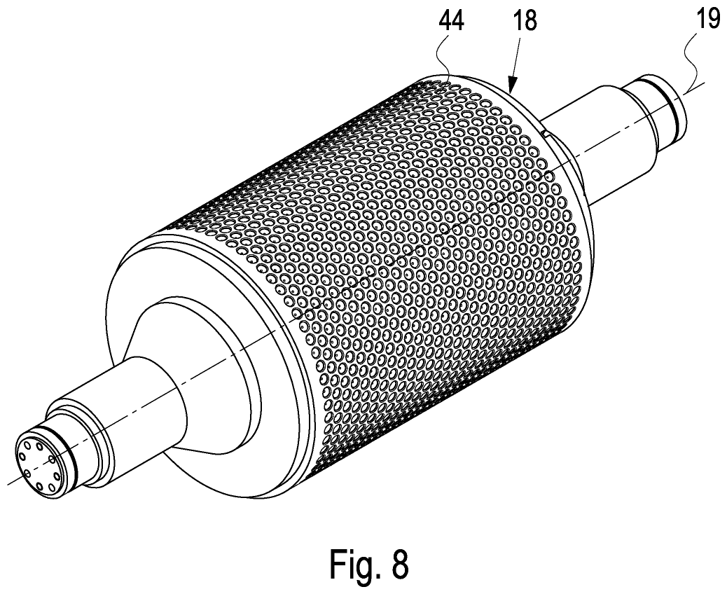

FIG. 8 shows a perspective view of the counter roller 18, wherein the embossing recesses 44 of the counter roller 18 can be seen.

It can be seen from FIGS. 5 and 6 that the press roller 20 has a smooth circumferential surface. FIG. 9 shows a schematic, sketch-like view of the web tension sensor 58. The web tension sensor 58 has three rotatably mounted, non-driven deflection rolls 62, 64, 66, whose axes of rotation 68 or 70 or 72 in FIG. 10 extend into the drawing plane and are arranged at the corner points of a triangle. The deflection rolls 62 and 66 are fixedly mounted, while the deflection roll 64 is movably mounted along a linear measurement axis 74 in the direction of a double arrow 76. The deflection roll 64 therein can be pretensioned by spring means into an initial position, shown as an example in FIG. 9. If, starting from this starting position, the web tension of the first paper web 6 increases, the deflection roll 64 in FIG. 9 moves upwards. This movement can be detected via a force transducer, for example, using strain gauges, or in some other way and supplied as a sensor output signal from the web tension sensor 58 to a central controller of the device, which will be explained in more detail below.

FIG. 10 shows the structure of a central system control of the device, which has a control device 78, in the form of a block diagram. The control device 78 can be designed in a variety of ways, with a combination of hardware and software in accordance with the respective requirements and circumstances, for example and in particular, as a programmable logic controller (PLC).

A rotary drive device 80, 82, or 84 that is controllable by the control device 78 is associated with the storage rolls 2, 4 for the webs 6, 8 and the storage roll 22 for the finished packaging material. During operation of the device, the control device 78 controls the speed of the rotary drive devices 80, 82, 84 in such a way that the desired web tension of the paper webs 6, 8 is set. For this purpose, the web tension sensors 58, 60 are in signal transmission connection with the control device 78.

A rotary drive device 86, 88, or 90 that is controllable by the control device 78 is associated with each of the rollers 16, 18, 20. During operation of the device, the control device 78 controls the speed of the rotary drive devices 86, 88, 90 in such a way that the rollers 16, 18, 20 for embossing the first web 6 in the embossing region 30 and for press-fitting the webs 6, 8 in the pressing region 32 run in sync.

To heat the rollers 16, 18, 20, a heating device 92 or 94 or 96 is associated with them, which is preferably integrated in the respective roller 16 or 18 or 20 and, for example and in particular, can be formed by at least one electric heating rod integrated in the respective roller 16 or 18 or 20.

To detect the temperature, a temperature measuring device 98, 100, 102, which is preferably also integrated into the respective roller 16 or 18 or 20, for example, in the form of a temperature sensor, is associated with each of the rollers 16, 18, 20. The temperature measuring devices 98, 100, 102 are in signal transmission connection with the control device 78. During operation of the device, the control device 78 controls the temperature of the rollers 16, 18, 20 by appropriately controlling the heating devices 92, 94, 96. The temperature can be controlled, in particular, in such a way that the temperature of embossing roller 16 is higher than the temperature of counter roller 18, and the temperature of counter roller 18 is higher than the temperature of press roller 20, so that there is a temperature gradient from the embossing roller 16 to the press roller 20.

Reference number 104 in FIG. 10 denotes a motorized adjustment apparatus for setting the gap width of the press roller gap along a linear axis running radially relative to the press roller axis of rotation 21. The motorized adjustment device is also controllable by the control device 78, for example, to adjust the gap width of the press roller gap to paper webs of different thicknesses or to disengage the press roller 20 from the counter roller 18 if the device is to be used for producing packaging material that exclusively consists of a single “embossing web” provided with shaped regions without a “carrier web.”

By means of a method according to the invention, using the device according to the invention, a packaging material according to the invention is produced in the manner of a bubble wrap.

In FIG. 11, a blank 106 of a corresponding bubble wrap-like packaging material is shown as an example, where it can be seen that the packaging material is provided with nub-like shaped regions 11 arranged in a grid-like manner. The structural composition of the packaging material according to the invention is similar to that of conventional bubble wrap made of plastic, but differs from it in that it is made exclusively of paper or cellulose.

It can be seen from FIG. 11 that the shaped regions 11 in the paper web plane of the “embossing web” 6 are each limited by a closed circumferential line, which is circular or approximately circular in the illustrated exemplary embodiment.

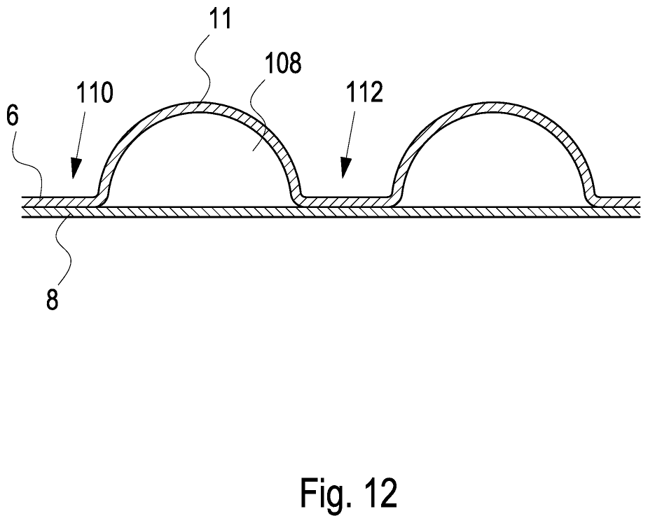

FIG. 12 shows a section through the packaging material on a greatly enlarged scale compared to FIG. 11. It can be seen that the embossment 11 in the first paper web 6 with the smooth second paper web 8 delimits an enclosed cavity 108. Away from the embossments 11, the paper webs 6, 8 are press-fitted against each other in web-like connecting sections 110, 112.

In the illustrated exemplary embodiment, the paper webs 6, 8 are made of recycled paper that has at least one, in particular, all of the following characteristic parameters:
specific basis weight/grammage [ISO 536]: 60-140 g/m2
water absorption according to Cobb60 [ISO 535]: 26-113 g/m2
roughness according to Bendtsen [ISO 8791-2]: ≥300 ml/min
bursting strength [ISO 2758]: 160-240 kPa
SCT INDEX in cross-direction [ISO 9895]: 1.1-1.9 kN/m

Depending on the respective requirements and circumstances, other types or grades of paper can also be used for the paper webs 6, 8. The paper webs 6, 8 therein can, in particular, be made of the same type of paper. However, according to the invention, it is also possible to use different types of paper for the paper webs 6, 8.

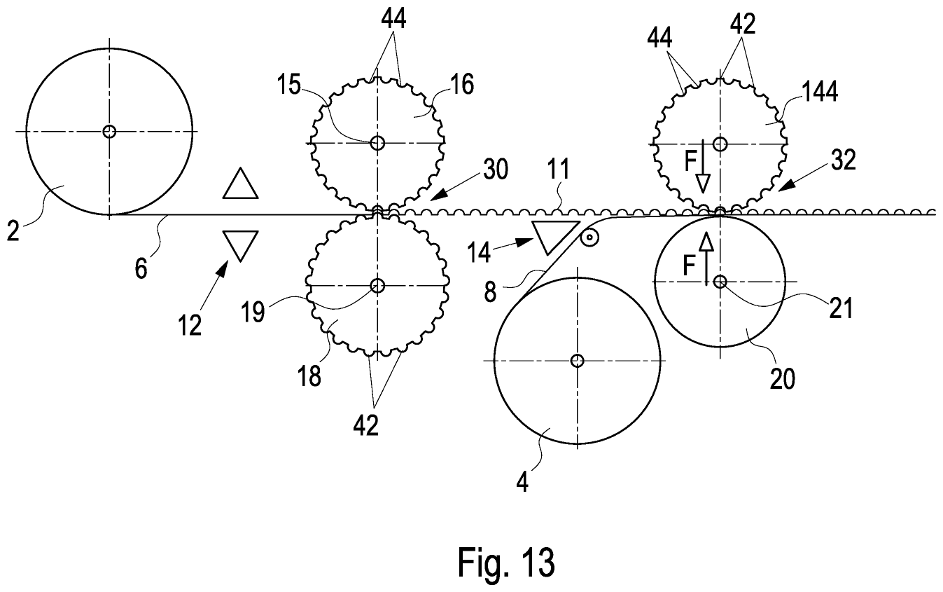

FIG. 13 shows a second exemplary embodiment of a device according to the invention, which differs from the first exemplary embodiment primarily in that, in the feed direction or conveying direction of the webs 6, 8, the pressing region 32 of the device is spaced apart from the embossing region 30. Due to the spatial distance between the pressing region 32 and the embossing region 30, the embossing roller 16 and the press roller 18 do not have a common counter roller in this exemplary embodiment. Rather, the counter roller 18 is associated with the embossing roller 16 and a separate counter roller 114 is associated with the press roller 20.

While, in the first exemplary embodiment according to FIGS. 1 to 10, the rollers 16, 18, 20 of the roller arrangement 10 form a combined embossing and pressing station, the second exemplary embodiment has an embossing station (embossing roller 16/counter roller 18) and a pressing station (press roller 20/counter roller 114) spaced apart from the embossing station in the feed direction or conveying direction.

1. A device for producing packaging material from paper,
with means for feeding at least one first paper web and one second paper web to an embossing region and to a pressing region downstream of the embossing region in the feed direction of the paper webs,
with an embossing apparatus arranged in the embossing region of the device for embossing the first paper web, wherein the embossing apparatus is designed and set up in such a way that shaped regions are created from the first paper web and project beyond the first paper web and each being limited by a closed circumferential line in the paper web plane of the first paper web,
with a pressing apparatus arranged in the pressing region of the device for press-fitting the paper webs free of adhesive and connecting synthetic auxiliary material, in particular free of plastics film, wherein the pressing apparatus is designed and set up in such a way that, in connecting portions between the shaped regions, paper fibers of the first paper web are connected to paper fibers of the second paper web, and wherein the paper webs limit closed cavities in the region of the shaped regions, and
with preconditioning means arranged in the feed direction upstream of the embossing region and/or the pressing region with at least one preconditioning apparatus for preconditioning the first paper web and/or the second paper web for embossing the first paper web or press-fitting the paper webs together.

2. The device according to claim 1, wherein at least one preconditioning apparatus is designed and set up for applying or introducing a preconditioning liquid, which is or contains preferably water, onto or into at least one of the paper webs.

3. The device according to claim 1, wherein at least one preconditioning apparatus is designed and set up for spraying, nebulizing or evaporating a preconditioning liquid in such a way that the preconditioning liquid is sprayed, nebulized or evaporated onto the associated paper web.

4. The device according to claim 1, wherein at least one preconditioning apparatus, in particular a preconditioning apparatus associated with the first paper web, is designed and set up for steaming the associated paper web with steam.

5. The device according to claim 1, wherein each of the paper webs is associated with a separate preconditioning apparatus for separate, in particular, different preconditioning of the paper webs.

6. The device according to claim 1, wherein the first paper web is associated with a first preconditioning apparatus which is arranged on the feed path of the first paper web to the embossing region, and wherein the second paper web is associated with a second preconditioning apparatus which is arranged on the feed path of the second paper web to the pressing region.

7. The device according to claim 1, wherein at least one preconditioning apparatus, in particular, a preconditioning apparatus associated with the second paper web, is designed and set up for introducing or applying a preconditioning liquid, preferably water, that contains cellulose fibers or cellulose particles, wherein the cellulose fibers or cellulose particles preferably are or contain microcellulose and/or nanocellulose, in particular, cellulose microfibers (CMF) and/or cellulose nanofibers (CNF).

8. The device according to claim 1, wherein a roller arrangement with an embossing roller, which is rotatably mounted about an embossing roller axis of rotation and has embossing projections on its circumferential surface for forming the shaped regions in the first paper web, is arranged in the embossing region, wherein the embossing roller is engaged with a counter roller which is rotatably mounted about an axis of rotation parallel to the embossing roller axis of rotation and has embossing recesses on its circumferential surface which are designed to be complementary to the embossing projections of the embossing roller.

9. The device according to claim 8, wherein a press roller which is rotatably mounted about a press roller axis of rotation is arranged in the pressing region and which, for press-fitting the first paper web with the second paper web, cooperates with a rotatably mounted counter roller, the axis of rotation of which is parallel relative to the press roller axis of rotation and spaced apart in such a way that a press roller gap is formed between the press roller and the counter roller for press-fitting the first paper web with the second paper web away from the shaped regions in the connecting portions of the paper webs.

10. The device according to claim 9, wherein the counter roller of the embossing roller and the counter roller of the press roller are formed by a common counter roller, such that the roller arrangement has three rollers that are operatively engaged with one another.

11. The device according to claim 10, wherein the counter roller axis of rotation is arranged on a straight connecting line between the embossing roller axis of rotation of the and the press roller axis of rotation of the.

12. The device according to claim 9, wherein a preferably motor-driven adjustment apparatus is associated with the press roller for setting the gap width of the press roller gap along a linear axis running radially relative to the press roller axis of rotation.

13. The device according to claim 8, wherein a heating device for heating the respective rollers is associated with the embossing roller and/or the counter roller and/or the press roller for setting the temperature of the rollers preferably separately.

14. The device according to claim 8, wherein at least one temperature sensor is associated with the embossing roller and/or the counter roller and/or the press roller, respectively, for detecting the temperature of the respective roller.

15. The device according to claim 1, wherein drying means for drying the paper webs, that were press-fitted against each other in the pressing region, are arranged in the feed direction between the pressing region and the storage means for the finished packaging material.

16. The device according to claim 15, wherein the drying means has at least two drying apparatuses, which are spaced apart from one another in the feed direction.

17. The device according to claim 15, wherein at least one drying apparatus is designed as an infrared radiation device and at least one drying apparatus is designed as a hot-air drying apparatus.

18. The device according to claim 17, wherein the press roller consists of an elastic, flexible material, in particular, silicone, at least on its circumferential surface.

19. A method for producing packaging material from paper, wherein at least one first paper web and at least one second paper web are fed to an embossing region and a pressing region downstream of the embossing region in the feed direction of the paper webs,
wherein shaped regions are created from the first paper web in the embossing region by means of an embossing apparatus, the shaped regions projecting beyond the first paper web, and wherein each is limited by a closed circumferential line in the paper web plane of the first paper web,
wherein the paper webs, free of adhesive and connecting synthetic auxiliary material, in particular, free of plastics film, are press-fitted against each other in the pressing region by means of a pressing apparatus in such a way that, in connecting portions between the shaped regions, paper fibers of the first paper web connect to paper fibers of the second paper web, and the paper webs limit closed cavities in the region of the shaped regions, and
wherein, in preparation of the embossing action in the embossing region or press-fitting action of the paper webs in the pressing region, the first paper web and/or the second paper web are/is preconditioned.

20. The method according to claim 19, wherein at least one of the paper webs is preconditioned by introducing or applying a preconditioning liquid thereto, which is preferably water or contains water.

21. The method according to claim 20, wherein the preconditioning liquid is sprayed, nebulized or evaporated onto the associated paper web.

22. The method according to claim 19, wherein the first paper web is steamed with steam for preconditioning the same.

23. The method according to claim 19, wherein the paper webs are preconditioned by means of separate preconditioning apparatuses in particular, they are preconditioned differently.

24. The method according to claim 19, wherein the first paper web is preconditioned by means of a first preconditioning apparatus, which is arranged on the feed path of the first paper web to the embossing region, and the second paper web is preconditioned by means of a second preconditioning apparatus, which is arranged on the feed path of the second paper web to the pressing region.

25. The method according to claim 19, wherein at least one paper web, in particular, the second paper web, is preconditioned by introducing or applying a preconditioning liquid thereto, preferably water, which contains cellulose fibers or cellulose particles, preferably microcellulose and/or nanocellulose, in particular, cellulose microfibers (CMF) and/or cellulose nanofibers (CNF).

26. The method according to claim 19, wherein a roller arrangement with an embossing roller, which is mounted rotatably about an embossing roller axis of rotation, is used in the embossing region, and which has embossing projections on its circumferential surface for forming the shaped regions in the first paper web, wherein the embossing roller is engaged with a counter roller which is rotatably mounted about an axis of rotation parallel relative to the embossing roller axis of rotation and has embossing recesses on its circumferential surface which are designed to be complementary to the embossing projections of the embossing roller.

27. The method according to claim 19, wherein a press roller, which is rotatably mounted about a press roller axis of rotation, is used in the pressing region, and which, for press-fitting the first paper web with the second paper web, cooperates with a counter roller, the axis of rotation of which is spaced apart from the press roller axis of rotation in such a way that a press roller gap is formed between the press roller and the counter roller for press-fitting the first paper web with the second paper web, away from the shaped regions, in the connecting portions of the first paper web.

28. The method according to claim 27, wherein a common counter roller is used as the counter roller of the embossing roller and as the counter roller of the press roller, such that the roller arrangement has three rollers that are operatively engaged with one another.

29. The method according to claim 28, wherein the counter roller axis of rotation is arranged on a straight connecting line between the embossing roller axis of rotation and the press roller axis of rotation.

30. The method according to claim 27, wherein a press roller with a preferably motor-driven adjustment apparatus is used for setting the gap width of the press roller gap along a linear axis running radially relative to the press roller axis of rotation.

31. The method according to claim 27, wherein the embossing roller and/or the counter roller and/or the press roller is/are heated.

32. The method according to claim 27, wherein the temperature of the embossing roller and/or the counter roller and/or the press roller is/are measured.

33. The method according to claim 32, wherein the paper webs, press-fitted against each other in the pressing region, are dried, in the feed direction, between the pressing region and a storage space for the finished packaging material.

34. The method according to claim 33, wherein the paper webs, press-fitted against each other, are dried in several stages by at least two drying apparatuses spaced apart from one another in the feed direction.

35. The method according to claim 33, wherein the paper webs, press-fitted against each other, are dried by means of at least one drying apparatus designed as an infrared radiation device and by at least one drying apparatus designed as a hot air drying apparatus.

36. The method according to claim 19, wherein a press roller is used which consists of an elastically flexible material, in particular, silicone, at least on its circumferential surface.

37. (canceled)

38. A packaging material made of paper,
with a first paper web and with a second paper web,
wherein shaped regions are created from at least one paper web, the shaped regions projecting beyond the paper web and each being limited by a closed circumferential line in the paper web plane,
characterized in that
the paper webs, on their surfaces facing one another, are made exclusively of paper and press-fitted against each other free of adhesive and connecting synthetic auxiliary material, in particular free of plastics film, preferably after preconditioning of the paper webs, in such a way that in connecting portions between the shaped regions, paper fibers of the first paper web are connected to paper fibers of the second paper web and wherein the paper webs limit closed cavities in the region of the shaped regions.

39. The packaging material according to claim 38, characterized in that the circumferential line limiting a shaped region is, in each case, circular or approximately circular, such that the shaped regions are formed like spherical surfaces.

40. The packaging material according to claim 38, characterized in that shaped regions are created from both paper webs and that the paper webs are connected to one another in such a way that shaped regions in one paper web are arranged opposite corresponding shaped regions in the other paper web.

41. The packaging material according to claim 38, characterized in that the shaped regions form a regular pattern, in particular, they are arranged in rows and/or columns.

42. The packaging material according to claim 38, characterized in that the paper webs consist of recycled paper.

43. The packaging material according to claim 42, characterized in that the recycled paper has at least one, in particular all of the following characteristic parameters:
specific basis weight/grammage [ISO 536]: 60-140 g/m2
water absorption according to Cobb60 [ISO 535]: 26-113 g/m2
roughness according to Bendtsen [ISO 8791-2]: ≥300 ml/min
bursting strength [ISO 2758]: 160-240 kPa
SCT INDEX in cross direction [ISO 9895]: 1.1-1.9 kN/m.

44. The packaging material according to claim 38, characterized in that the connecting portions between the shaped regions are designed in a web-like manner.

45. The packaging material according to claim 38, characterized in that the paper webs are compressed at least in sections in the connecting portions.

46. Use of recycled paper for the production of a packaging material, which has at least one paper web from which shaped regions are created, which project beyond the paper web and are each limited by a closed circumferential line in the paper web plane, wherein the recycled paper has at least one, in particular all of the following characteristic parameters:
specific basis weight/grammage [ISO 536]: 60-140 g/m2
water absorption according to Cobb60 [ISO 535]: 26-113 g/m2—roughness according to Bendtsen [ISO 8791-2]: ≥300 ml/min
bursting strength [ISO 2758]: 160-240 kPa
SCT INDEX in cross direction [ISO 9895]: 1.1-1.9 kN/m.
